(19) United States
(12) Patent Application Publication
(10) Pub. No.: US 2010/0095163 A1
(43) Pub. Date: Apr. 15, 2010

(54) MONITORING ERROR NOTIFICATION FUNCTION SYSTEM

(75) Inventors: Reiko Ishihara, Kawasaki (JP); Masami Taoda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/567,012

(22) Filed: Sep. 25, 2009

(30) Foreign Application Priority Data
Oct. 15, 2008 (JP) 2008-266789

(51) Int. Cl. G06F 11/34

(52) U.S. Cl. 714/47; 714/E11.2

(57) ABSTRACT

A system for monitoring error notification function comprising: an information processing apparatus including: a first processor including error notification function for generating error information indicative of an error occurred at least one component in the information processing apparatus; a first communication unit for sending the error information; and a management server including; a second communication unit for receiving the error information from the information processing apparatus; a second processor for monitoring the error notification function in accordance with a process including: instructing the information processing apparatus to generate a pseudo error command for urging the information processing apparatus to generate pseudo error information; wherein the second processor in the management server determines whether the error notification function in the system is operating properly or not by checking receipt of pseudo error information from the information processing apparatus.

### CROSS-REFERENCE TO RELATED APPLICATION

This application is based upon and claims the benefit of priority of the prior Japanese Patent Application No. 2008-266789, filed on Oct. 15, 2008, the entire contents of which are incorporated herein by reference.

### FIELD

A certain aspect of the embodiments discussed herein relates to a technique of monitoring error notification function in an information processing apparatus.

### BACKGROUND

As is well known, an information processing device includes elements such as a storage unit and a Central Processing Unit (CPU). Some information processing devices have anomaly reporting functions of reporting, when an anomaly occurs in an element, the anomaly to an external device.

To implement the anomaly reporting functions, a function of generating, when an anomaly occurs in an element, a type code for identifying the type of the anomaly and a function of generating and sending an error message that includes the generated type code are built in an information processing device. Moreover, a reporting device that receives the sent error message and sends the error message to an external device is connected to the information processing device.

In the past, a function of diagnosing whether a function of generating an error message and sending the error message to a reporting device normally works and notifying an external device of the diagnosis result did not exist. Thus, a maintenance person and the like who use an external device have not been capable of checking whether the anomaly reporting functions of an information processing device normally work as a whole.

Japanese Laid-open Patent Publication No. 56-076852, Japanese Laid-open Patent Publication No. 04-369046 and Japanese Laid-open Patent Publication No. 05-324389 disclose techniques of monitoring error notification function in an information processing apparatus.

### SUMMARY

According to an aspect of an embodiment, a system for monitoring error notification function comprising: an information processing apparatus including: a plurality of components for executing processes; a first processor including error notification function for generating error information indicative of an error occurred at least one component in the information processing apparatus so as to notify the error occurred at least one component; a first communication unit for sending the error information; and a management server including; a second communication unit for receiving the error information from the information processing apparatus; a second processor for monitoring the error notification function in the system in accordance with a process including: instructing the information processing apparatus to generate a pseudo error command for urging the information processing apparatus to generate pseudo error information so as to check the operation of the error notification function in the system; wherein the second processor in the management server determines whether the error notification function in the system is operating properly or not by checking receipt of pseudo error information from the information processing apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a server management system according to the present embodiment.

FIG. 2 is a block diagram of a monitoring target server machine.

FIG. 3 is a block diagram of a management server machine.

FIG. 4 schematically illustrates a registration information table.

FIG. 5 illustrates an example of a periodic diagnosis reception screen.

FIG. 6 schematically illustrates a type table.

FIG. 7 schematically illustrates a parts table.

FIG. 8 is a block diagram of a periodic diagnosis module.

FIG. 9 schematically illustrates a pseudo fault occurrence record table.

FIG. 10 is a block diagram of a maintenance person machine.

FIG. 11 schematically illustrates an event log table.

FIG. 12 illustrates the flow of a pseudo error code generation process.

FIG. 13 illustrates the flow of an error code determination process.

FIG. 14 illustrates the flow of the error code determination process.

FIG. 15 illustrates the flow of a customer notification process.

FIG. 16 illustrates the flow of the customer notification process.

FIG. 17 schematically illustrates the components of a monitoring target server machine according to a second modification.

FIG. 18 schematically illustrates the components of a monitoring target server machine according to a third modification.

### DESCRIPTION OF EMBODIMENTS

A server management system according to the present embodiment will now be described with reference to the drawings.

[Components]

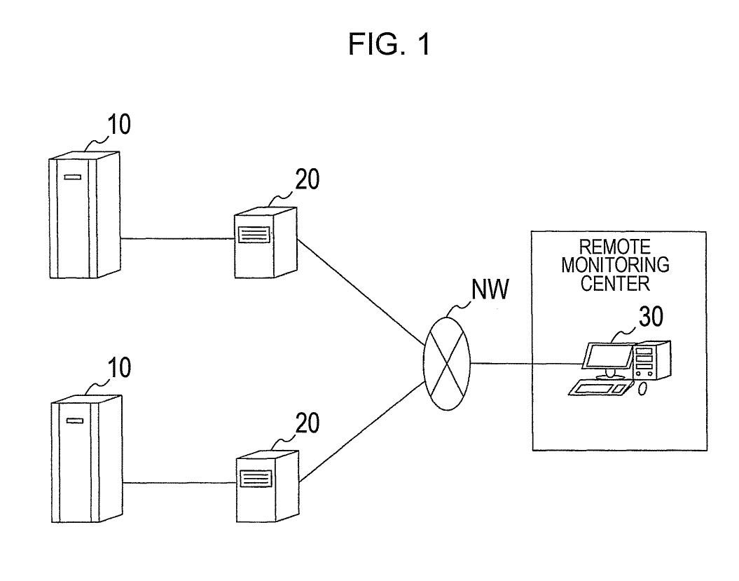

FIG. 1 is a block diagram of the server management system according to the present embodiment.

The server management system according to the present embodiment is a system used by a vendor that provides maintenance service for monitoring target server machines 10 to customers and includes the monitoring target server machines 10, management server machines 20, and a maintenance person machine 30.

Each of the monitoring target server machines 10 is a machine that provides various types of service to client machines (not illustrated) via a network and is a machine to be monitored by a corresponding one of the management server machines 20. The monitoring target server machine 10, together with the management server machine 20, is installed in facilities of a customer who receives maintenance service.

The management server machine 20 is a machine that reports, when after-mentioned functions in the monitoring target server machine 10 send an error message because a fault occurs in one of the units (the elements) that constitute the monitoring target server machine 10, the fault as an anomaly to the maintenance person machine 30.

The maintenance person machine 30 is a machine that notifies a maintenance person, a customer, and the like of an anomaly in the monitoring target server machine 10 reported from the management server machine 20. The maintenance person machine 30 is installed in facilities of a remote monitoring center. The maintenance person machine 30 is connected to the management server machine 20 via a network NW so that the maintenance person machine 30 can freely communicate with the management server machine 20, as illustrated in FIG. 1.

While the single monitoring target server machine 10 is connected to the management server machine 20 in FIG. 1, the two or more monitoring target server machines 10 may be connected to the management server machine 20. Moreover, while the two management server machines 20 are connected to the maintenance person machine 30 in FIG. 1, the three or more management server machines 20 may be connected to the maintenance person machine 30.

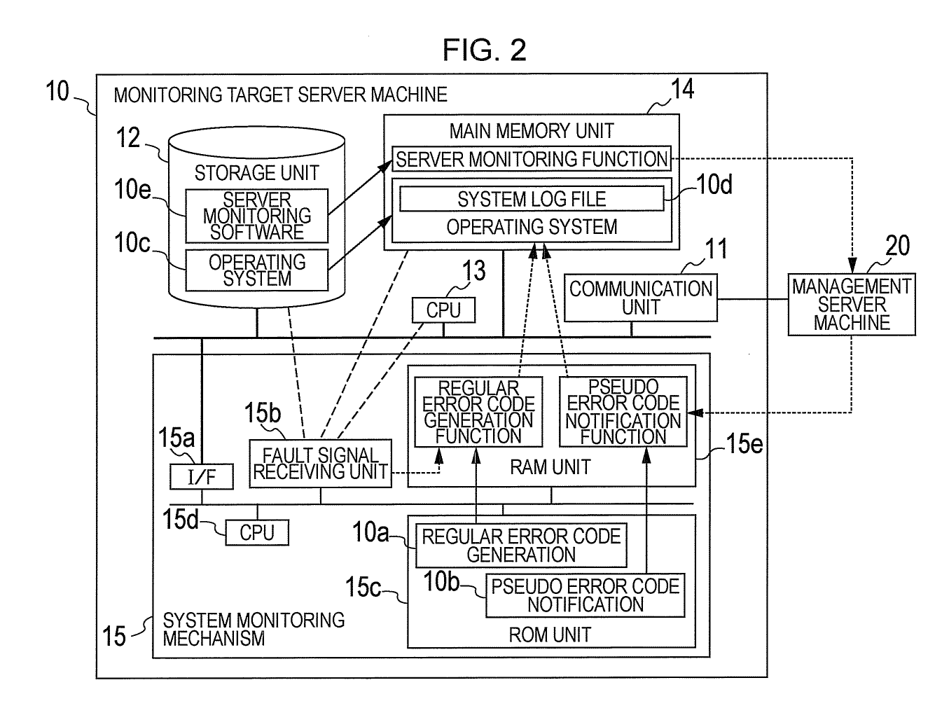

FIG. 2 is a block diagram of the monitoring target server machine 10.

The monitoring target server machine 10 includes a communication unit 11, a storage unit 12, a Central Processing Unit (CPU) 13, a main memory unit 14, and a system monitoring mechanism 15.

The communication unit 11 is a unit for exchanging data with another computer. The communication unit 11 includes, for example, an Ethernet (a trademark of Xerox Corporation, USA) card, a Fiber Channel (FC) card, an Asynchronous Transfer Mode (ATM) card, a token ring card, or a Fiber-distributed data interface (FDDI) card. In the present embodiment, the communication unit 11 is connected to the management server machine 20 via a cable so that the communication unit 11 can freely communicate with the management server machine 20.

The storage unit 12 is a unit that, for example, records various types of programs and various types of data on a recording medium and reads them from the recording medium. The storage unit 12 includes, for example, a solid state drive unit, a hard disk drive unit, a Digital Versatile Disk (DVD) drive unit, a +R/+RW drive unit, or a Blu-ray Disk (BD) drive unit. Moreover, a recording medium includes, for example, a silicon disk including a nonvolatile semiconductor memory (a flash memory), a hard disk, a DVD (including a DVD-Recordable [R], a DVD-Rewritable [RW], a DVD-Read Only Memory [ROM], or a DVD-Random Access Memory [RAM]), a +R/+RW, or a BD (including a BD-R, a BD-Rewritable [RE], or a BD-ROM).

The CPU 13 is a unit that performs processing in the monitoring target server machine 10 according to programs in the storage unit 12. The main memory unit 14 is a unit in which the CPU 13, for example, caches programs, data, and the like and creates a work area.

The system monitoring mechanism 15 is a service processor that receives a fault signal output from a unit (an element) such as the storage unit 12 or the CPU 13 when a fault occurs and generates an error code corresponding to the received fault signal.

Specifically, the system monitoring mechanism 15 illustrated in FIG. 2 includes an InterFace (I/F) unit 15a, a fault signal receiving unit 15b, a Read Only Memory (ROM) unit 15c, a CPU 15d, and a RAM unit 15e.

The I/F unit 15a is a unit for exchanging data with the communication unit 11, the CPU 13, and the main memory unit 14. The fault signal receiving unit 15b is a unit that receives a fault signal from units (elements) such as the storage unit 12 and the CPU 13. The ROM unit 15c is a unit in which various types of programs and various types of data are recorded. The CPU 15d is a unit that perform processing in the system monitoring mechanism 15 according to programs in the ROM unit 15c. The Random Access Memory (RAM) unit 15e is a unit in which the CPU 15d, for example, caches programs, data, and the like and creates a work area.

The system monitoring mechanism 15 stores a regular error code generation program 10a and a pseudo error code notification program 10b in the ROM unit 15c. FIG. 2 illustrates a state in which the regular error code generation program 10a and the pseudo error code notification program 10b are read from the ROM unit 15c and loaded into the RAM unit 15e as functions.

The regular error code generation program 10a is a program for, when the fault signal receiving unit 15b has received a fault signal from a unit, generating a regular error code corresponding to the fault signal and sending the regular error code to an operating system 10c. When the fault signal receiving unit 15b has received a fault signal sent by a unit due to a fault, the CPU 15d generates a type code for identifying the type of the anomaly (the fault) and a part code for identifying the unit, which has sent the fault signal, according to the regular error code generation program 10a. Then, the CPU 15d combines the generated type code and part code according to the regular error code generation program 10a. The CPU 15d generates an error code by further adding, as a pseudo flag, one-bit information that indicates whether the error code is a regular error code or a pseudo error code to the end of the combination of the type code and the part code. Thus, a function of the CPU 15d for executing the regular error code generation program 10a corresponds to a generation unit described above. In the present embodiment, when a pseudo flag at the end is “1”, an error code is a pseudo error code, and when the pseudo flag is “0”, the error code is a regular error code that indicates occurrence of an actual fault.

The pseudo error code notification program 10b is a program for notifying, when a pseudo error code has been transferred from the management server machine 20 via the communication unit 11 and the operating system 10c, the operating system 10c of the received pseudo error code. A pseudo error code transferred from the management server machine 20 includes a predetermined type code and a predetermined part code as well as one-bit information, as a pseudo flag, that indicates whether an error code is a pseudo error code. A part code included in a pseudo error code is not information for identifying a unit in which a fault has actually occurred and is information for identifying a unit that is set as a pseudo fault source. Moreover, a type code included in a pseudo error code is information for identifying the type of a pseudo anomaly (a fault) that is assumed to occur in a unit that is set as a pseudo fault source.

The monitoring target server machine 10 stores the operating system 10c and server monitoring software 10e in the storage unit 12. FIG. 2 illustrates a state in which the operating system 10c and the server monitoring software 10e are read from the storage unit 12 and loaded into the main memory unit 14.

The operating system 10c is software for providing Application Programming Interfaces (APIs), Application Binary Interfaces (ABIs), and the like to various types of application programs, managing storage areas of the storage unit 12, the main memory unit 14, and the like, managing processes, tasks, and the like, providing utilities such as file management, various types of setting tools, and editors to application programs, and assigning windows to a plurality of tasks to provide multiple screen outputs. The operating system 10c includes a communication interface program (not illustrated). The communication interface program is a program for exchanging data with a communication interface program in another computer that is connected, in the present embodiment, the management server machine 20, via the communication unit 11. The communication interface program includes the Transmission Control Protocol/Internet Protocol (TCP/IP) suite. The operating system 10c further includes a system logging function. The system logging function is a function of recording, as logs, fault information, login information, and performance information reported from various types of hardware, various types of systems, and the like in a system log file 10d. When a regular error code or a pseudo error code has been received from the system monitoring mechanism 15, the system logging function generates an error message that includes the received regular error code or pseudo error code and records the error message in the system log file 10d. An error message includes date and time information that indicates the date and time of occurrence of a fault and the part name of a failed unit in addition to a regular error code or a pseudo error code. In this case, when the error code is a pseudo error code, date and time information that indicates date and time when the pseudo error code notification program 10b sent a notification of the pseudo error code is illustrated as date and time information that indicates the date and time of occurrence of a fault.

The server monitoring software 10e monitors various types of information recorded in the system log file 10d. When an error message has been recorded in the system log file 10d, the server monitoring software 10e obtains the recorded error message from the system log file 10d and sends the obtained error message to the management server machine 20. An error message to be sent to the management server machine 20 includes a regular error code and date and time information that indicates date and time when an actual fault occurred or a pseudo error code and date and time information that indicates date and time when the operating system 10c was notified of the pseudo error code.

Thus, both a regular error code and a pseudo error code are sent to the management server machine 20 via the operating system 10c, the system log file 10d, and a server monitoring function based on the server monitoring software 10e in this order. Thus, a function of the CPU 13 for executing the operating system 10c and the server monitoring software 10e in the monitoring target server machine 10 corresponds to a transmission unit described above.

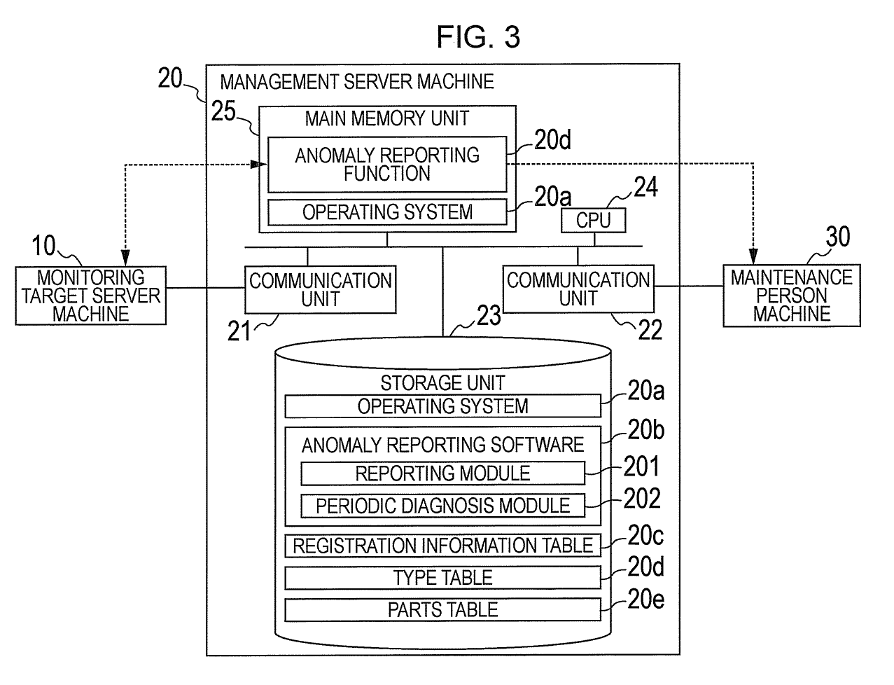

FIG. 3 is a block diagram of the management server machine 20.

The management server machine 20 includes communication units 21 and 22, a storage unit 23, a CPU 24, and a main memory unit 25.

Each of the communication units 21 and 22 is a unit for exchanging data with another computer. That is, each of the communication units 21 and 22 performs a function equivalent to that of the communication unit 11 in the monitoring target server machine 10 and includes, for example, the network cards exemplified above. In the present embodiment, the communication unit 21 is connected to the monitoring target server machine 10 so that the communication unit 21 can freely communicate with the monitoring target server machine 10, and the communication unit 22 is connected to the maintenance person machine 30 via a network so that the communication unit 22 can freely communicate with the maintenance person machine 30.

The storage unit 23 is a unit in which various types of programs and various types of data are recorded on a recording medium so that the various types of programs and the various types of data can be freely read and written. That is, the storage unit 23 performs a function equivalent to that of the storage unit 12 in the monitoring target server machine 10 and is a drive unit that includes, for example, the recording media exemplified above.

The CPU 24 is a unit that performs processing in the management server machine 20 according to programs in the storage unit 23. The main memory unit 25 is a unit in which the CPU 24, for example, caches programs, data, and the like and creates a work area.

The management server machine 20 stores an operating system 20a, anomaly reporting software 20b, a registration information table 20c, a type table 20d, and a parts table 20e in the storage unit 23. FIG. 3 illustrates a state in which the operating system 20a and the anomaly reporting software 20b are read from the storage unit 23 and loaded into the main memory unit 25.

The operating system 20a performs a function equivalent to that of the operating system 10c in the monitoring target server machine 10 and includes a communication interface program.

The anomaly reporting software 20b is software for reporting, when the server monitoring function based on the server monitoring software 10e in the monitoring target server machine 10 has sent an error message, an anomaly in the monitoring target server machine 10 to the maintenance person machine 30 on the basis of the error message. The anomaly reporting software 20b includes a reporting module (a program) 201 and a periodic diagnosis module (a program) 202.

The reporting module 201 is a program for reporting, when an error message that includes a regular error code that indicates occurrence of an actual fault has been received from the monitoring target server machine 10, an anomaly in the monitoring target server machine 10 to the maintenance person machine 30 by generating a report message on the basis of the error message and sending the generated report message. A report message includes the host name of the monitoring target server machine 10 and an error message. Since an error message regarding occurrence of an actual fault includes a regular error code and date and time information that indicates date and time when the actual fault occurred, as described above, a report message also includes them. Moreover, a report message may include a type name and a part name respectively corresponding to a type code and a part code included in a regular error code.

The periodic diagnosis module 202 is a program for periodically diagnosing whether a series of anomaly reporting functions normally works, the series of anomaly reporting functions including generating an error message using the system logging function of the operating system 10c in the monitoring target server machine 10, obtaining the error message from the system log file 10d using the server monitoring function based on the server monitoring software 10e, sending the error message to the management server machine 20 using the server monitoring function, and reporting an anomaly to the maintenance person machine 30 using the reporting module 201 in the anomaly reporting software 20b in the management server machine 20.

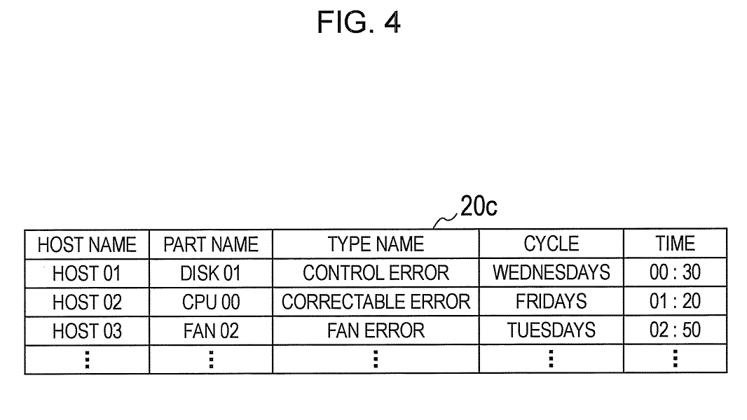

The registration information table 20c is a table for storing information on periodic diagnoses of the anomaly reporting functions. FIG. 4 schematically illustrates the registration information table 20c. Each record of the registration information table 20c illustrated in FIG. 4 includes “host name”, “part name”, “type name”, “cycle”, and “time” fields. The “host name” field is a field in which the host name of the monitoring target server machine 10 subjected to a periodic diagnosis of the anomaly reporting functions is recorded. The “part name” field is a field in which the part name of a unit that is set as a pseudo fault source in a periodic diagnosis of the anomaly reporting functions is recorded. The “type name” field is a field in which the name of the type of a pseudo anomaly (a fault) that is assumed to occur in a unit that is set as a pseudo fault source in a periodic diagnosis of the anomaly reporting functions is recorded. The “cycle” field is a field in which the execution cycle of a periodic diagnosis of the anomaly reporting functions is recorded. In an example in FIG. 4, a day of the week is recorded as “cycle”. The “time” field is a field in which execution time in the execution date of a periodic diagnosis of the anomaly reporting functions is recorded.

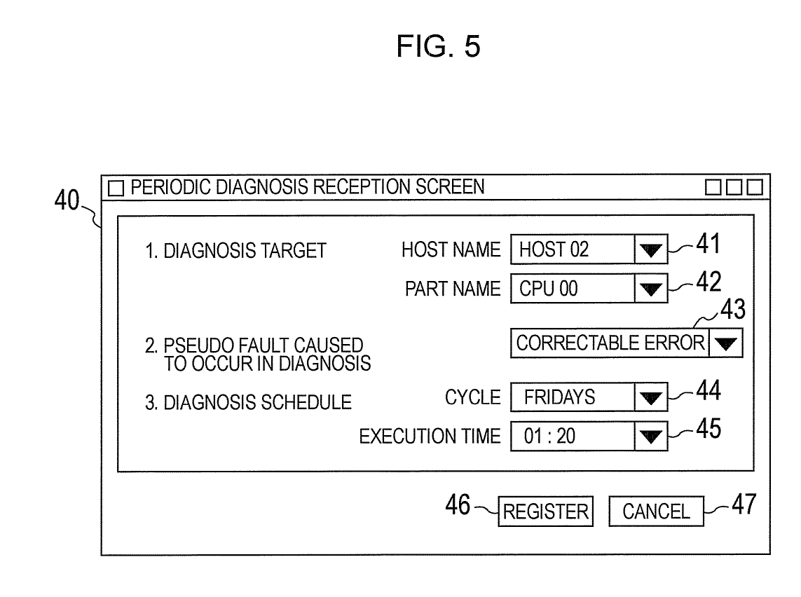

Information on periodic diagnoses of the anomaly reporting functions may be registered in the registration information table 20c through a periodic diagnosis reception screen to be displayed on a display area of a control console (a console) (not illustrated) connected to the management server machine 20. FIG. 5 illustrates an example of a periodic diagnosis reception screen 40. The periodic diagnosis reception screen 40 illustrated in FIG. 5 includes five combo boxes 41 to 45 and two buttons 46 and 47. Each of the combo boxes 41 to 45 is a Graphical User Interface (GUI) that has a function in which functions of a drop down list box and an edit field are combined. The combo box 41 is a combo box for inputting the name of the monitoring target server machine 10 subjected to a periodic diagnosis of the anomaly reporting functions. The combo box 42 is a combo box for inputting the part name of a unit that is set as a pseudo fault source in a periodic diagnosis of the anomaly reporting functions, out of units included in the monitoring target server machine 10 subjected to a periodic diagnosis of the anomaly reporting functions. The combo box 43 is a combo box for inputting the name of the type of a pseudo anomaly (a fault) that is assumed to occur in a unit that is set as a pseudo fault source in a periodic diagnosis of the anomaly reporting functions. The combo box 44 is a combo box for inputting the execution cycle of a periodic diagnosis of the anomaly reporting functions, for example, a day of the week. The combo box 45 is a combo box for inputting execution time in the execution date of a periodic diagnosis of the anomaly reporting functions. The button 46 is a register button for registering, in the registration information table 20c, a periodic diagnosis determined by pieces of information input to the combo boxes 41 to 45. The button 47 is a cancel button for canceling an operation of registering information on a periodic diagnosis in the registration information table 20c. An operator (a user) can register information on a periodic diagnosis of the anomaly reporting functions in the registration information table 20c by, through a control console (not illustrated), inputting predetermined information in each of the combo boxes 41 to 45 on the periodic diagnosis reception screen 40 illustrated in FIG. 5 and then clicking the register button 46.

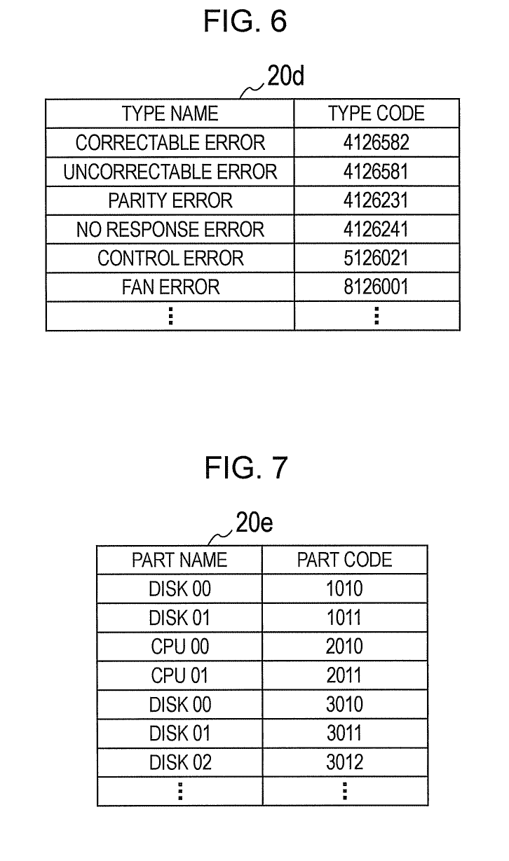

The type table 20d illustrated in FIG. 3 is a table in which the respective type names of anomalies (faults) that may occur in each unit in the monitoring target server machine 10 and type codes are defined to be in association with each other. FIG. 6 schematically illustrates the type table 20d. Each record of the type table 20d illustrated in FIG. 6 includes “type name” and “type code” fields. The “type name” field is a field in which the name of a fault type is recorded. The “type code” field is a field in which a type code corresponding to a fault type is recorded.

The parts table 20e illustrated in FIG. 3 is a table in which the respective part names of units in the monitoring target server machine 10 and part codes are defined to be in association with each other. FIG. 7 schematically illustrates the parts table 20e. Each record of the parts table 20e illustrated in FIG. 7 includes “part name” and “part code” fields. The “part name” field is a field in which the part name of a unit is recorded. The “part code” field is a field in which a part code corresponding to a unit is recorded.

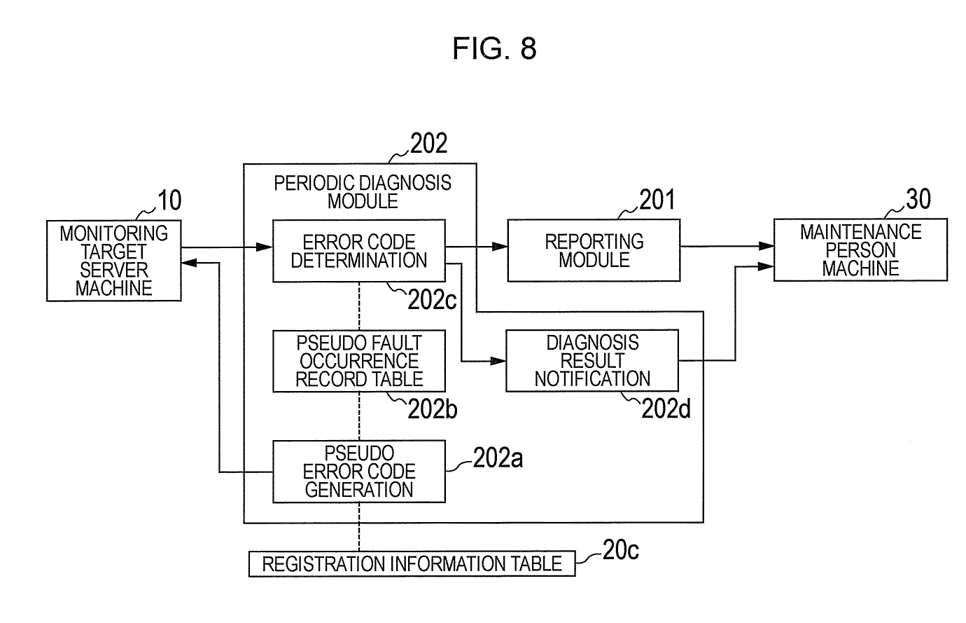

FIG. 8 is a block diagram of the periodic diagnosis module 202.

The periodic diagnosis module 202 includes a pseudo error code generation program 202a, a pseudo fault occurrence record table 202b, an error code determination program 202c, and a diagnosis result notification program 202d.

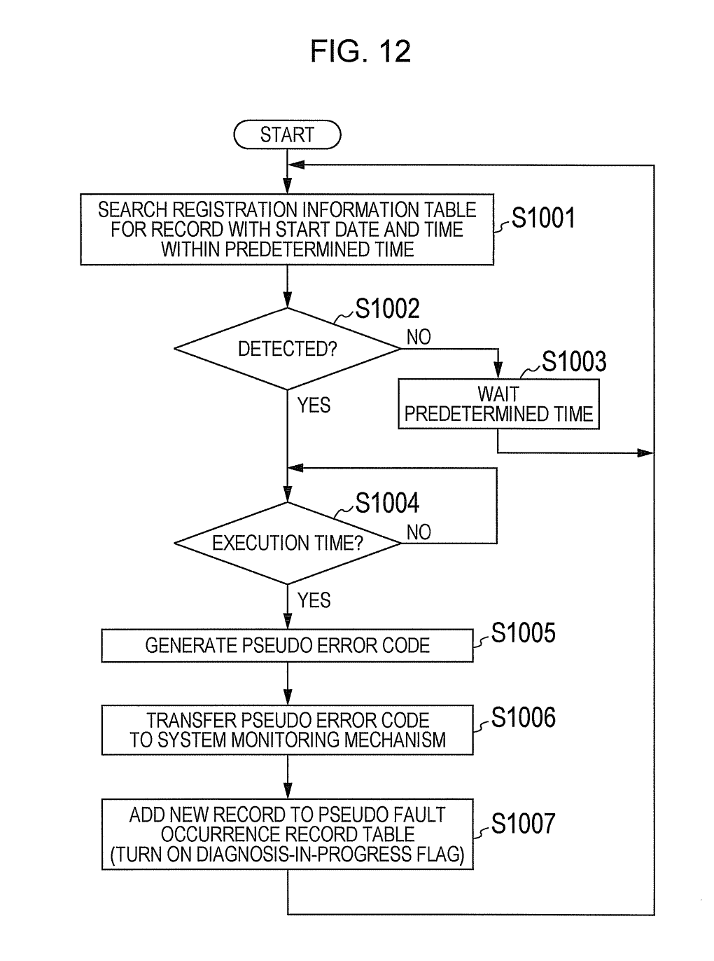

The pseudo error code generation program 202a is a program for generating a pseudo error code and transferring the pseudo error code to the pseudo error code notification program 10b in the monitoring target server machine 10. The content of operations performed by the CPU 24 according to the pseudo error code generation program 202a will be described below, using FIG. 12.

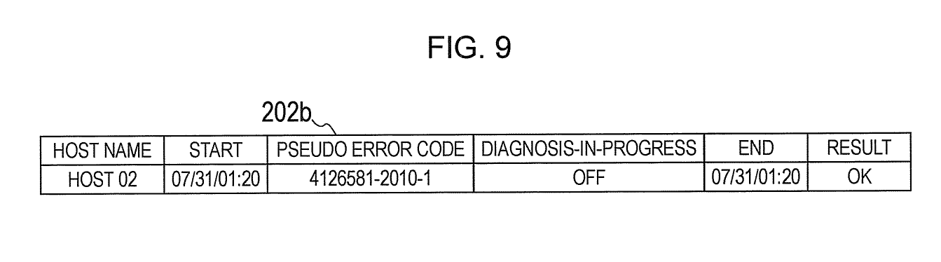

The pseudo fault occurrence record table 202b is a table in which information on execution of a periodic diagnosis of the anomaly reporting functions is recorded. FIG. 9 schematically illustrates the pseudo fault occurrence record table 202b. Each record of the pseudo fault occurrence record table 202b illustrated in FIG. 9 includes “host name”, “start”, “pseudo error code”, “diagnosis-in-progress”, “end”, and “result” fields. The “host name” field is a field in which the host name of the monitoring target server machine 10, for which a periodic diagnosis of the anomaly reporting functions was performed, is recorded. The “start” field is a field in which the execution start date and time of a periodic diagnosis of the anomaly reporting functions are recorded. The “pseudo error code” field is a field in which a pseudo error code that is transferred to the pseudo error code notification program 10b in a periodic diagnosis of the anomaly reporting functions is recorded. The “diagnosis-in-progress” field is a field in which a diagnosis-in-progress flag that indicates whether a periodic diagnosis of the anomaly reporting functions is being performed is recorded. In the present embodiment, when a periodic diagnosis is being performed, a diagnosis-in-progress flag is set to “ON”, and when a periodic diagnosis is completed, a diagnosis-in-progress flag is set to “OFF”, as described below. The “end” field is a field in which date and time when an error message was received from the server monitoring function based on the server monitoring software 10e in a periodic diagnosis of the anomaly reporting functions, i.e., date and time when the periodic diagnosis was completed, are recorded. The “result” field is a field in which a diagnosis result is recorded, the diagnosis result indicating whether operations on a path from the operating system 10c in the monitoring target server machine 10 to the management server machine 20, out of a path from the operating system 10c in the monitoring target server machine 10 to the maintenance person machine 30 in the anomaly reporting functions, are normal or abnormal. When the operations on the path from the operating system 10c in the monitoring target server machine 10 to the management server machine 20 are normal, OK (Okay) is recorded as a diagnosis result, and when the operations on the path from the operating system 10c in the monitoring target server machine 10 to the management server machine 20 are abnormal, NG (No Good) is recorded as a diagnosis result.

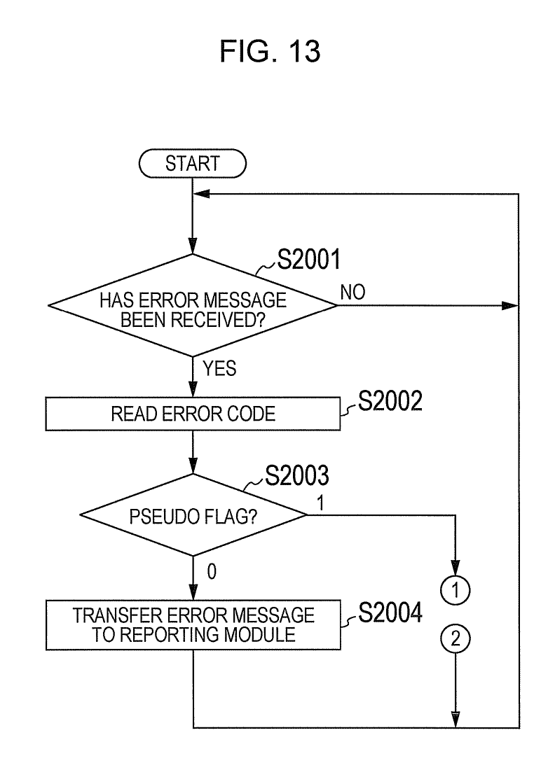

The error code determination program 202c illustrated in FIG. 8 is a program for receiving an error message from the server monitoring function based on the server monitoring software 10e in the monitoring target server machine 10, when an error code included in the received error message is a regular error code that indicates occurrence of an actual fault, transferring the error message to the reporting module 201, and when the error code included in the received error message is a pseudo error code regarding a periodic diagnosis, transferring the error message to the diagnosis result notification program 202d. The content of operations performed by the CPU 24 according to the error code determination program 202c will be described below, using FIGS. 12 and 13.

The diagnosis result notification program 202d is a program for obtaining, from the error code determination program 202c, the result of the diagnosis of the operations on the path from the operating system 10c in the monitoring target server machine 10 to the management server machine 20, out of the path from the operating system 10c in the monitoring target server machine 10 to the maintenance person machine 30 in the anomaly reporting functions, and notifying the maintenance person machine 30 of the diagnosis result by generating a diagnosis result notification message on the basis of the obtained diagnosis result and sending the generated diagnosis result notification message. A diagnosis result notification message includes the host name of the monitoring target server machine 10, an error message, and a text “normal” or “anomaly” that indicates a diagnosis result. In this case, since an error message regarding a periodic diagnosis includes a pseudo error code and date and time information that indicates date and time when the operating system 10c in the monitoring target server machine 10 was notified of the pseudo error code, as described, a diagnosis result notification message also includes them.

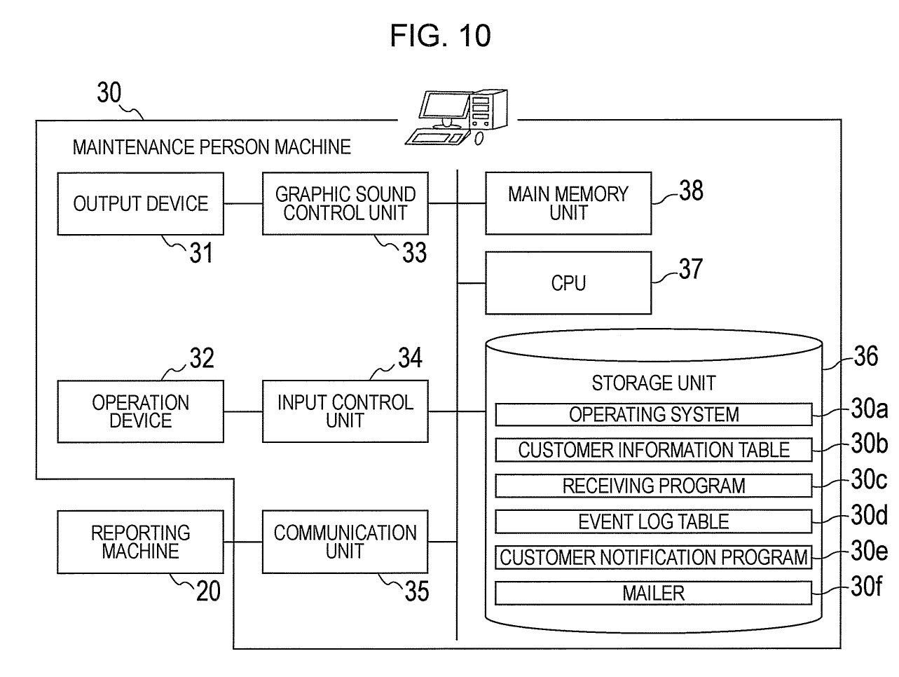

FIG. 10 is a block diagram of the maintenance person machine 30.

The maintenance person machine 30 includes an output device 31 such as a liquid crystal display provided with a speaker, an operation device 32 such as a keyboard and a mouse, and a main body to which these devices 31 and 32 are connected. The main body includes a graphic sound control unit 33, an input control unit 34, a communication unit 35, a storage unit 36, a CPU 37, a main memory unit 38, and the like.

The graphic sound control unit 33 is a unit that generates audio-visual signals on the basis of audio-visual data transferred from the CPU 37 and outputs the audio-visual signals to the output device 31. The input control unit 34 is a unit that receives operational signals from the operation device 32 and notifies the CPU 37 of the operational signals.

The communication unit 35 is a unit that exchanges data with another computer. That is, the communication unit 35 performs a function equivalent to that of the communication unit 11 in the monitoring target server machine 10 and includes the network cards exemplified above. In the present embodiment, the communication unit 35 is connected to the management server machine 20 via the network NW so that the communication unit 35 can freely communicate with the management server machine 20.

The storage unit 36 is a unit in which various types of programs and various types of data are recorded on a recording medium so that the various types of programs and the various types of data can be freely read and written. That is, the storage unit 36 performs a function equivalent to that of the storage unit 12 in the monitoring target server machine 10 and is a drive unit that includes the recording media exemplified above.

The CPU 37 is a unit that performs processing in the maintenance person machine 30 according to programs in the storage unit 36. The main memory unit 38 is a unit in which the CPU 37, for example, caches programs, data, and the like and creates a work area.

The maintenance person machine 30 stores an operating system 30a, a customer information table 30b, a receiving program 30c, an event log table 30d, a customer notification program 30e, and a mailer 30f in the storage unit 36.

The operating system 30a performs a function equivalent to that of the operating system 10c in the monitoring target server machine 10 and includes a communication interface program.

The customer information table 30b is a table in which the host name of the monitoring target server machine 10 and an electronic mail address of a customer who receives maintenance service for the monitoring target server machine 10 are managed to be in association with each other. When the new management server machine 20 is installed in facilities of a customer, a maintenance person connects an operator console (a console) (not illustrated) to the management server machine 20 and registers various types of information in the maintenance person machine 30 from the operator console so that the new management server machine 20 is placed under the control of the maintenance person machine 30. A host name and an electronic mail address registered in the customer information table 30b may be those registered in the maintenance person machine 30 by this registration operation.

The receiving program 30c is a program for receiving a report message from the reporting module 201 in the management server machine 20, receiving a diagnosis result notification message from the periodic diagnosis module 202, and recording the report message and the diagnosis result notification message in the event log table 30d. Moreover, to show a maintenance person an anomaly in the monitoring target server machine 10 or the result of a periodic diagnosis of the anomaly reporting functions, upon receiving a report message or a diagnosis result notification message, the receiving program 30c also displays the content of the message on the output device 31.

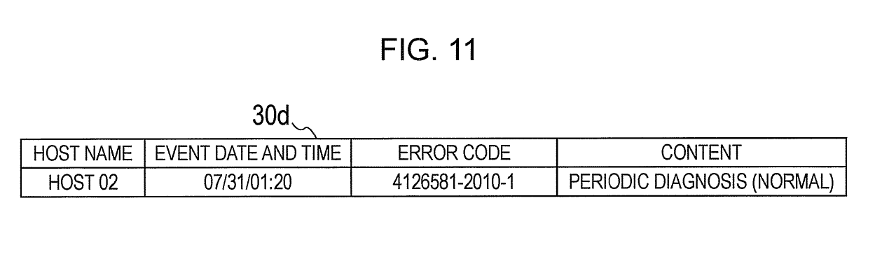

The event log table 30d is a table for storing the content of a report message or a diagnosis result notification message received by the receiving program 30c from the management server machine 20. FIG. 11 schematically illustrates the event log table 30d. Each record of the event log table 30d illustrated in FIG. 11 includes “host name”, “event date and time”, “error code”, and “content” fields. The “host name” field is a field in which a host name included in a report message or a diagnosis result notification message is recorded. That is, in the “host name” field, the host name of the monitoring target server machine 10, in which an actual fault occurred, or the host name of the monitoring target server machine 10 subjected to a periodic diagnosis of the anomaly reporting functions is recorded. The “event date and time” field is a field in which date and time information included in a report message or a diagnosis result notification message is recorded. That is, in the “event date and time” field, date and time information that indicates date and time when an actual fault occurred or date and time information that indicates date and time when the operating system 10c in the monitoring target server machine 10 was notified of a pseudo error code in a periodic diagnosis of the anomaly reporting functions is recorded. The “error code” field is a field in which a regular error code included in a report message or a pseudo error code included in a diagnosis result notification message is recorded. In the “content” field, information indicating whether a message received by the receiving program 30c is a report message or a diagnosis result notification message is recorded. Moreover, when a message received by the receiving program 30c is a diagnosis result notification message, in the “content” field, information that indicates the result of a periodic diagnosis of the anomaly reporting functions is further recorded. For example, when a received message is a report message regarding an actual fault, in the “content” field, a note stating that a regular fault occurred (for example, “anomaly report”) is recorded. In this case, in the “content” field, a type name (for example, “correctable error”) and a part name (for example, “CPU00”) respectively corresponding to a type code and a part code included in a regular error code may be recorded. Moreover, for example, when a received message is a diagnosis result notification message regarding a periodic diagnosis of the anomaly reporting functions, in the “content” field, a note stating that a periodic diagnosis was performed (for example, “periodic diagnosis”) and a text “normal” or “anomaly” that indicates a diagnosis result are recorded.

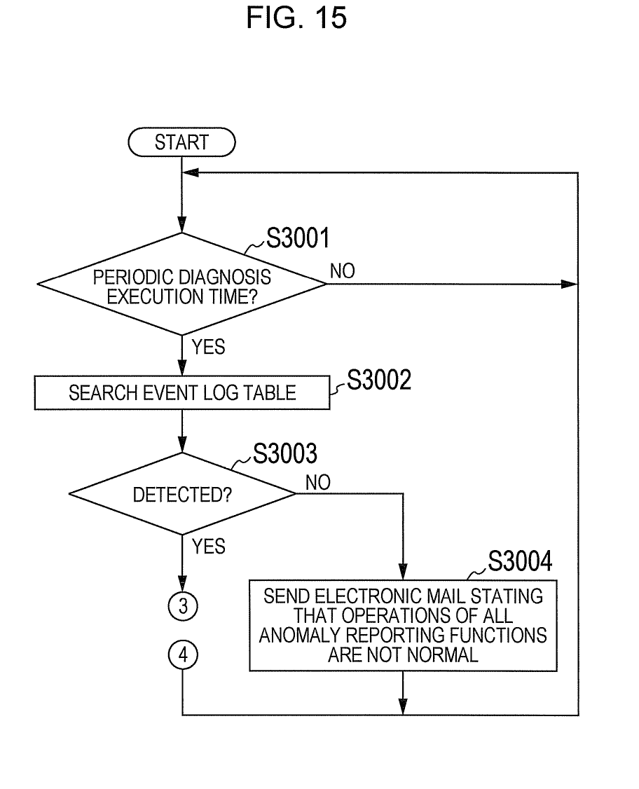

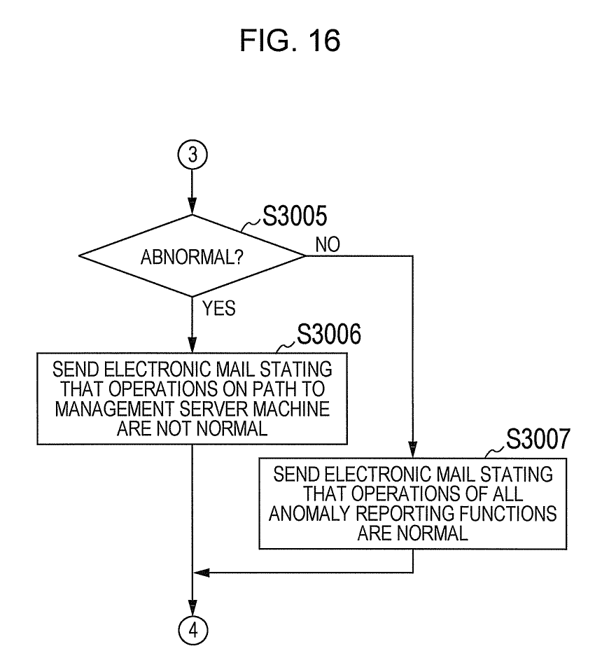

The customer notification program 30e illustrated in FIG. 10 is a program for sending a message recorded in the event log table 30d to a customer who receives maintenance service for the monitoring target server machine 10 related to the message. The content of operations performed by the CPU 37 according to the customer notification program 30e will be described below, using FIGS. 15 and 16.

The mailer 30f is software for implementing transmission, receipt, and edit of electronic mails.

[Process]

[Occurrence of Pseudo Fault]

In the management server machine 20 according to the present embodiment, when the main power supply is turned on, the operating system 20a is activated, and the pseudo error code generation program 202a is also activated. The CPU 24 starts a pseudo error code generation process upon activating the pseudo error code generation program 202a.

FIG. 12 illustrates the flow of the pseudo error code generation process in the management server machine 20.

After the pseudo error code generation process is started, in S1001, the CPU 24 searches the registration information table 20c in FIG. 4 for a record in which the due date of a cycle is the same as the time point of the start of the pseudo error code generation process, and the execution time of a periodic diagnosis of the anomaly reporting functions is within a predetermined time, for example, ten minutes, from the time point.

In S1002, the CPU 24 determines whether a record that meets a condition in S1001 has been detected in the registration information table 20c in FIG. 4. Then, when any record that meets the condition in S1001 has not been detected in the registration information table 20c in FIG. 4 (S1002; NO), the CPU 24 causes the process to branch from S1002 to S1003.

In S1003, the CPU 24 waits a predetermined time, for example, ten minutes, and subsequently causes the process to return to S1001.

On the other hand, when a record in which the start date and time of a periodic diagnosis is within the predetermined time has been detected in the registration information table 20c in FIG. 4 (S1002; YES), the CPU 24 causes the process to proceed from S1002 to S1004 to generate a pseudo error code.

In S1004, the CPU 24 waits until the execution time included in the record detected in the search in S1001 is reached. Then, when the execution time is reached (S1004; YES), the CPU 24 causes the process to proceed to S1005.

In S1005, the CPU 24 generates a pseudo error code. Specifically, the CPU 24 reads a type code “4126582” corresponding to a type name included in the record detected in the search in S1001, for example, “correctable error”, from the type table 20d in FIG. 6. The CPU 24 further reads a part code “2010” corresponding to a part name “CPU00” included in the same record from the parts table 20e in FIG. 7. Subsequently, the CPU 24 generates a pseudo error code “4126582-20104” by combining the read type code and part code and further adding a pseudo flag in a state “1” that indicates a pseudo error code to the end.

In S1006, the CPU 24 determines the monitoring target server machine 10 by a host name included in the record detected in the search in S1001 and transfers the pseudo error code generated in S1005 to a pseudo error code notification function based on the pseudo error code notification program 10b in the system monitoring mechanism 15 of the determined monitoring target server machine 10.

In S1007, the CPU 24 adds a new record to the pseudo fault occurrence record table 202b in FIG. 9. The added new record includes the host name and the date and time included in the record detected in the search in S1001, the pseudo error code transferred to the system monitoring mechanism 15 in S1006, and a diagnosis-in-progress flag. Since a diagnosis is being performed at the time of S1007, the diagnosis-in-progress flag is set to “ON”. In this case, the “end” and “result” fields in the new record are blank at this time. In S1007, the CPU 24 may further notify the maintenance person machine 30 of a message that includes a note stating that a periodic diagnosis of the anomaly reporting functions has been started. The message may include a text “A periodic diagnosis of the anomaly reporting functions has been performed.”, the name of a host in which a periodic diagnosis is performed, and date and time when the periodic diagnosis is started.

After the CPU 24 adds the aforementioned new record to the pseudo fault occurrence record table 200b in FIG. 9, the CPU 24 causes the process to return to S1001 to wait until the execution time of the next periodic diagnosis.

A function of the CPU 24 for executing S1001 to S1007 corresponds to that of a pseudo error generation unit described above.

In the pseudo error code generation process in FIG. 12, a pseudo error code regarding a periodic diagnosis of the anomaly reporting functions registered in the registration information table 20c in FIG. 4 is generated at the set date and time, and the generated pseudo error code is transferred to the pseudo error code notification function based on the pseudo error code notification program 10b in the system monitoring mechanism of the monitoring target server machine 10.

In this case, the pseudo error code notification function of the monitoring target server machine 10 notifies the operating system 10c in the monitoring target server machine 10 of the pseudo error code upon receiving the pseudo error code from the management server machine 20, as described above. Then, the operating system 10c in the monitoring target server machine 10 generates an error message that includes the notified pseudo error code and date and time information that indicates date and time when a notification of the pseudo error code was sent and records the error message in the system log file 10d (refer to FIG. 2).

Moreover, independent of the pseudo error code generation process in FIG. 12, in the monitoring target server machine 10, when a fault signal has been received from a unit in the monitoring target server machine 10 due to an actual fault in the unit, a regular error code generation function based on the regular error code generation program 10a generates a regular error code on the basis of the fault signal and transfers the regular error code to the operating system 10c, as described above. Even in the case of a regular error code received from the regular error code generation function, the operating system 10c in the monitoring target server machine 10 generates an error message and records the error message in the system log file 10d.

That is, in the system log file 10d in the monitoring target server machine 10, when an actual fault has occurred, an error message based on a regular error code is recorded, and when a periodic diagnosis of the anomaly reporting functions has been executed, an error message based on a pseudo error code is recorded.

Moreover, the server monitoring function based on the server monitoring software 10e in the monitoring target server machine 10 monitors the system log file 10d, and when an error message has been recorded in the system log file 10d, the server monitoring function obtains the error message and sends the error message to the management server machine 20, as described above. The sent error message is that including a regular error code and date and time information that indicates date and time when an actual fault occurred, for example, “Jul. 31, 2001:25 4126581-2010-0”, or that including a pseudo error code and date and time information that indicates date and time when the operating system 10c was notified of the pseudo error code, for example, “Jul. 31, 2001:20 4126581-2010-1”, as described above.

[Error Code Determination]

In the management server machine 20 according to the present embodiment, when the main power supply is turned on, the operating system 20a is activated, and the error code determination program 202c is also activated. The CPU 24 starts an error code determination process upon activating the error code determination program 202c.

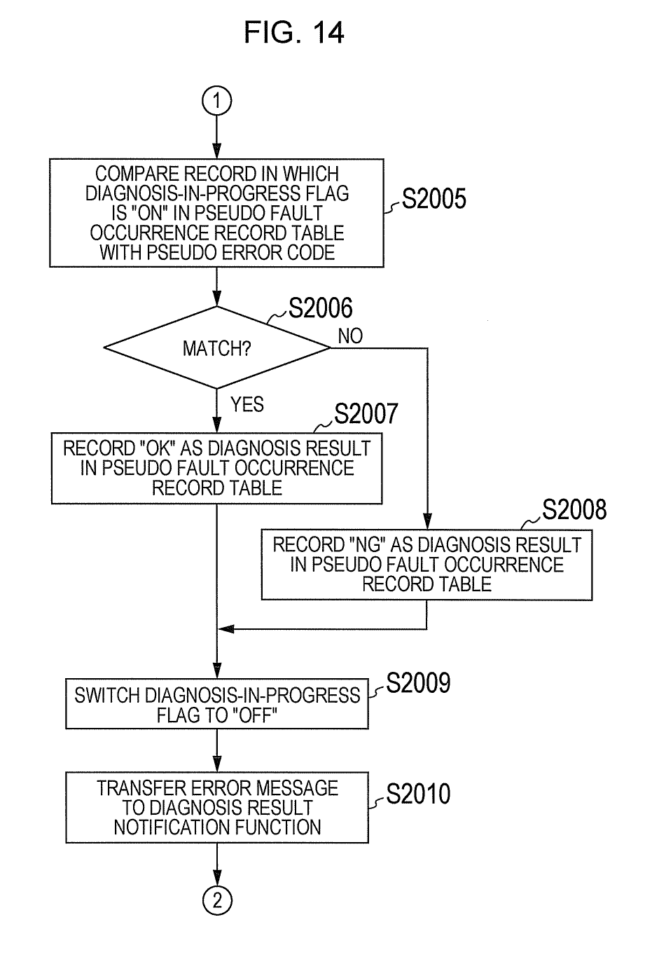

FIGS. 13 and 14 show the flow of the error code determination process in the management server machine 20.

After the error code determination process is started, in S2001, the CPU 24 waits until an error message is received from the server monitoring function based on the server monitoring software 10e in any one of the monitoring target server machines 10. Then, when an error message has been received from the server monitoring function of any one of the monitoring target server machines 10 (S2001; YES), the CPU 24 causes the process to proceed from S2001 to S2002.

A function of the CPU 24 for executing S2001 corresponds to that of a receiving unit described above.

In S2002, the CPU 24 reads an error code from the error message received in S2001.

In S2003, the CPU 24 determines whether a pseudo flag at the end of the error code read in S2002 is “0” or “1”. Then, when the pseudo flag at the end of the error code is “0”, i.e., when the error code is a regular error code that indicates an actual fault, the CPU 24 causes the process to proceed to S2004.

In S2004, the CPU 24 transfers the error message received in S2001 to the reporting module 201 (refer to FIG. 8). In this case, when an error message that includes a regular error code has been received, the reporting module 201 generates a report message on the basis of the received error message and sends the generated report message to the maintenance person machine 30, as described above. The sent report message includes the host name of the monitoring target server machine 10, a regular error code, and date and time information that indicates date and time when an actual fault occurred, as described above. After the CPU 24 transfers the error message to the reporting module 201, the CPU 24 causes the process to return to S2001 to wait until an error message is received from any one of the monitoring target server machines 10.

A function of the CPU 24 for executing S2002 to S2004 and the reporting module 201 corresponds to that of a reporting unit described above.

On the other hand, when the pseudo flag at the end of the error code read in S2002 is “1”, i.e., when the error code is a pseudo error code, the CPU 24 causes the process to branch from S2003 to S2005 in FIG. 14.

In S2005, the CPU 24 determines a record in which the diagnosis-in-progress flag is “ON” in the pseudo fault occurrence record table 202b in FIG. 9 and compares a pseudo error code included in the determined record with the pseudo error code read in S2002.

In S2006, the CPU 24 determines whether the pseudo error codes match each other in the comparison in S2005. Then, when the pseudo error codes match each other (S2006; YES), the CPU 24 determines that the operations on the path from the operating system 10c in the monitoring target server machine 10 to the management server machine 20, out of the path from the operating system 10c in the monitoring target server machine 10 to the maintenance person machine 30 in the anomaly reporting functions, are normal. Thus, the CPU 24 causes the process to proceed to S2007.

In S2007, the CPU 24 records, in the “end” field of the record, in which the diagnosis-in-progress flag is “ON”, in the pseudo fault occurrence record table 202b in FIG. 9, date and time information that indicates date and time when the error message was received from the server monitoring function based on the server monitoring software 10e in the monitoring target server machine 10 in S2001. The CPU 24 further records, in the “result” field of the same record, “OK” as a diagnosis result regarding the operations on the path from the operating system 10c in the monitoring target server machine 10 to the management server machine 20. Subsequently, the CPU 24 causes the process to proceed to S2009.

On the other hand, when the pseudo error codes do not match each other in the comparison in S2005 (S2006; NO), the CPU 24 determines that the operations on the path from the operating system 10c in the monitoring target server machine 10 to the management server machine 20 are abnormal for some reason. Thus, the CPU 24 causes the process to branch from S2006 to S2008.

In S2008, the CPU 24 records, in the “end” field of the record, in which the diagnosis-in-progress flag is “ON”, in the pseudo fault occurrence record table 202b in FIG. 9, date and time information that indicates date and time when the error message was received from the server monitoring function based on the server monitoring software 10e in the monitoring target server machine 10 in S2001. The CPU 24 further records, in the “result” field of the same record, “NG” as a diagnosis result regarding the operations on the path from the operating system 10c in the monitoring target server machine 10 to the management server machine 20. Subsequently, the CPU 24 causes the process to proceed to S2009.

In S2009, in the record, in which the diagnosis-in-progress flag is “ON”, in the pseudo fault occurrence record table 202b in FIG. 9, the CPU 24 switches the diagnosis-in-progress flag to “OFF” indicating that a diagnosis is not being performed.

A function of the CPU 24 for executing S2002 to S2009 corresponds to that of a determination unit described above.

In S2010, the CPU 24 transfers the error message received in S2001 to a diagnosis result notification function based on the diagnosis result notification program 202d. In this case, when an error message that includes a pseudo error code has been received, the diagnosis result notification function generates a diagnosis result notification message on the basis of the received error message and a diagnosis result corresponding to the error message in the pseudo fault occurrence record table 202b in FIG. 9 and sends the generated diagnosis result notification message to the maintenance person machine 30, as described above. The sent diagnosis result notification message includes the host name of the monitoring target server machine 10, a pseudo error code, date and time information that indicates date and time when the operating system 10c in the monitoring target server machine 10 was notified of the pseudo error code, and a text “normal” or “anomaly” that indicates a diagnosis result, as described above. Subsequently, the CPU 24 causes the process to return to S2001 in FIG. 13 to wait until an error message is received from any one of the monitoring target server machines 10.

A function of the CPU 24 for executing S2007 and the diagnosis result notification program 202d corresponds to that of a notification unit described above.

According to the error code determination process in FIGS. 13 and 14, it is determined whether an error code in an error message received from the monitoring target server machine 10 is a regular error code or a pseudo error code. Then, when the error code in the received error message is a regular error code, an anomaly in the monitoring target server machine 10 is reported to the maintenance person machine 30, as is the case with the known anomaly reporting functions.

On the other hand, when the error code in the received error message is a pseudo error code, it is determined whether the operations on the path from the operating system 10c in the monitoring target server machine 10 to the management server machine 20 are normal or abnormal. Then, a notification of the determination result is sent to the maintenance person machine 30 as the diagnosis result of the anomaly reporting functions.

[Customer Notification]

In the maintenance person machine 30 according to the present embodiment, when the main power supply is turned on, the operating system 30a is activated, and the customer notification program 30e is also activated. The CPU 37 starts a customer notification process upon activating the customer notification program 30e.

FIGS. 15 and 16 show the flow of the customer notification process.

After the customer notification process is started, in S3001, the CPU 37 determines whether time at which the management server machine 20 is to execute a periodic diagnosis of the anomaly reporting functions has come. In the present embodiment, when a maintenance person connects a control console (not illustrated) to the management server machine 20 and enters information on a periodic diagnosis through the periodic diagnosis reception screen 40 in FIG. 5, a copy of the entered information is sent to the maintenance person machine 30, and a copy of the registration information table 20c is generated in the maintenance person machine 30. Thus, the maintenance person machine 30 can determine date and time at which the management server machine 20 is to execute a periodic diagnosis of the anomaly reporting functions and the host name of the monitoring target server machine 10 subjected to a periodic diagnosis from the copy of the registration information table 20c. When time at which the management server machine 20 is to execute a periodic diagnosis of the anomaly reporting functions has come, the CPU 37 causes the process to proceed from S3001 to S3002.

In S3002, the CPU 37 searches the event log table 30d in FIG. 11, using, as search conditions, the time, at which the management server machine 20 is to execute a periodic diagnosis of the anomaly reporting functions, and a host name subjected to a periodic diagnosis.

In S3003, the CPU 37 determines whether a record that meets the search conditions in S3002 has been detected in the event log table 30d in FIG. 11. Then, when any record that meets the search conditions in S3002 has not been detected in the event log table 30d in FIG. 11 (S3003; NO), even though the time, at which the management server machine 20 is to execute a periodic diagnosis of the anomaly reporting functions, has come, any diagnosis result notification message has not been sent. Thus, the CPU 37 determines that the operations of all the anomaly reporting functions, i.e., operations on the path from the operating system 10c in the monitoring target server machine 10 to the maintenance person machine 30, are not normally working, and the CPU 37 causes the process to branch from S3003 to S3004.

In S3004, the CPU 37 sends an electronic mail stating that the operations of all the anomaly reporting functions are not normal to a customer. In S3004, the CPU 37 first determines an electronic mail address of the customer who receives maintenance service for the monitoring target server machine 10 having the host name set as the search condition in S3002 from the customer information table 30b. Then, the CPU 37 sends, to the determined electronic mail address, an electronic mail in which at least a note stating that the operations of all the anomaly reporting functions are not normal, for example, a text “The remote reporting process is not normally working.”, and the host name are described, using the function of the mailer 30f. Subsequently, the CPU 37 causes the process to return to S3001 to wait until the execution time of another periodic diagnosis.

On the other hand, when a record has been detected in the event log table 30d in FIG. 11 as a result of the search in S3002 (S3003; YES), the time, at which the management server machine 20 is to execute a periodic diagnosis of the anomaly reporting functions, has come, and a diagnosis result notification message has been sent. Thus, the CPU 37 determines that at least operations on a path from the management server machine 20 to the maintenance person machine 30, out of the path from the operating system 10c in the monitoring target server machine 10 to the maintenance person machine 30 in the anomaly reporting functions, are normally working, and the CPU 37 causes the process to proceed from S3003 to S3005 in FIG. 16 to further check the operations on the path from the operating system 10c in the monitoring target server machine 10 to the management server machine 20.

In S3005, the CPU 37 reads a diagnosis result from the “content” field of the record detected in the event log table 30d in FIG. 11 and determines whether the result of the diagnosis by the management server machine 20 is normal or abnormal. Then, when the result of the diagnosis by the management server machine 20 is abnormal (S3005; YES), the CPU 37 determines that one of the operations on the path from the operating system 10c in the monitoring target server machine 10 to the management server machine 20, i.e., generation of an error message, acquisition of an error message, and transmission and receipt of an error message, is not normally working. Thus, the CPU 37 causes the process to proceed to S3006.

In S3006, the CPU 37 sends, to the customer, an electronic mail stating that the operations on the path from the operating system 10c in the monitoring target server machine 10 to the management server machine 20 are not normal. In S3006, the CPU 37 first determines an electronic mail address of the customer who receives maintenance service for the monitoring target server machine 10 having the host name set as the search condition in S3002 from the customer information table 30b. Then, the CPU 37 sends, to the determined electronic mail address, an electronic mail in which at least a note stating that the operations on the path from the operating system 10c in the monitoring target server machine 10 to the management server machine 20 are not normal, for example, a text “The fault monitoring process is not normally working.”, and the host name are described, using the function of the mailer 30f. Subsequently, the CPU 37 causes the process to return to S3001 in FIG. 15 to wait until the execution time of another periodic diagnosis.

On the other hand, when the result of the diagnosis by the management server machine 20 is normal (S3005; NO), the CPU 37 determines that, even on the path from the operating system 10c in the monitoring target server machine 10 to the management server machine 20, the operations are normal. Thus, the CPU 37 causes the process to branch from S3005 to S3007.

In S3007, the CPU 37 sends an electronic mail stating that the operations of all the anomaly reporting functions are normal to the customer. In S3007, the CPU 37 first determines an electronic mail address of the customer who receives maintenance service for the monitoring target server machine 10 having the host name set as the search condition in S3002 from the customer information table 30b. Then, the CPU 37 sends, to the determined electronic mail address, an electronic mail in which at least a note stating that the operations of all the anomaly reporting functions are normal, for example, a text “The fault monitoring process/remote reporting process have been normally executed.”, and the host name are described, using the function of the mailer 30f. Subsequently, the CPU 37 causes the process to return to S3001 to wait until the execution time of another periodic test.

[Operations and Effects]

According to the present embodiment, when the system monitoring mechanism 15 has received a fault signal from a unit in the monitoring target server machine 10 due to occurrence of an actual fault in the unit, the regular error code generation function based on the regular error code generation program 10a in the system monitoring mechanism 15 generates a regular error code on the basis of a part code and a type code that respectively indicate the failed unit and the type of the fault and notifies the operating system 10c of the regular error code. Then, the system logging function in the operating system 10c generates an error message that includes the regular error code and records the error message in the system log file 10d. Moreover, in the monitoring target server machine 10, the server monitoring function based on the server monitoring software 10e monitors the system log file 10d. When the error message has been recorded in the system log file 10d, the server monitoring function obtains the error message and sends the error message to the management server machine 20. In the management server machine 20, it is determined that the error code in the error message is a regular error code (S2001 to S2002, S2003; 0, S2004). Subsequently, the reporting module 201 generates a report message on the basis of the error message including the regular error code and sends the report message to the maintenance person machine 30. In the maintenance person machine 30, the receiving program 30c displays an anomaly in the monitoring target server machine 10 on the output device 31.

In the present embodiment, in the monitoring target server machine 10, in addition to the aforementioned anomaly reporting functions, functions of periodically diagnosing whether the operations of the anomaly reporting functions are normal are provided. Specifically, in the present embodiment, the periodic diagnosis module 202 is built in the anomaly reporting software 20b in the management server machine 20, and the pseudo error code notification program 10b coordinating with the periodic diagnosis module 202 is built in the system monitoring mechanism 15 in the monitoring target server machine 10.

Thus, the management server machine 20 according to the present embodiment periodically generates a pseudo error code according to information registered in the registration information table 20c (S1001 to S1005) and transfers the generated pseudo error code to the pseudo error code notification function based on the pseudo error code notification program 10b in the system monitoring mechanism 15 of the monitoring target server machine 10 (S1006). Subsequently, the pseudo error code notification function causes the operating system 10c to recognize occurrence of a pseudo fault by notifying the upstream side of the operating system 10c of the pseudo error code. Thus, the management server machine 20 receives an error message from the monitoring target server machine 10 in response to transfer of the pseudo error code. Thus, the management server machine 20 can determine, on the basis of the content of the received error message, whether the operations (generation of an error message, acquisition of an error message, and transmission and receipt of an error message) on the path from the operating system 10c in the monitoring target server machine 10 to the management server machine 20 in the anomaly reporting functions are normal (S2001, S2002, S2003; 1, S2005 to S2009). Subsequently, the diagnosis result notification program 202d notifies the maintenance person machine 30 of the determination result about the operations on the path from the operating system 10c in the monitoring target server machine 10 to the management server machine 20 as a diagnosis result notification message (S2010). Thus, a maintenance person can check whether not only the operations on the path from the management server machine 20 to the maintenance person machine 30 but also all the anomaly reporting functions of the monitoring target server machine 10 are normally working.

[Modifications]

While, in the embodiment described above, the pseudo error code notification program 10b is installed in the system monitoring mechanism 15 in the monitoring target server machine 10, and the pseudo error code notification program 10b is set to coordinate with the periodic diagnosis module 202 in the anomaly reporting software 20b in the management server machine 20, the arrangement is not limited to the embodiment to implement the anomaly reporting system disclosed above.

In a first modification, for example, a main component that generates a pseudo error code may not be the periodic diagnosis module 202 in the anomaly reporting software 20b in the management server machine 20 and may be the pseudo error code notification program 10b in the system monitoring mechanism 15 in the monitoring target server machine 10. In the first modification, the type table 20d and the parts table 20e are prepared in the system monitoring mechanism 15. The periodic diagnosis module 202 only indicates the part name of a unit in which a pseudo fault is caused to occur and the name of the type of the pseudo fault to the pseudo error code notification function based on the pseudo error code notification program 10b in the system monitoring mechanism 15, and the pseudo error code notification function generates a pseudo error code on the basis of the part name and the name of the type related to the pseudo fault. In this case, the pseudo error code notification function notifies the operating system 10c of the generated pseudo error code.

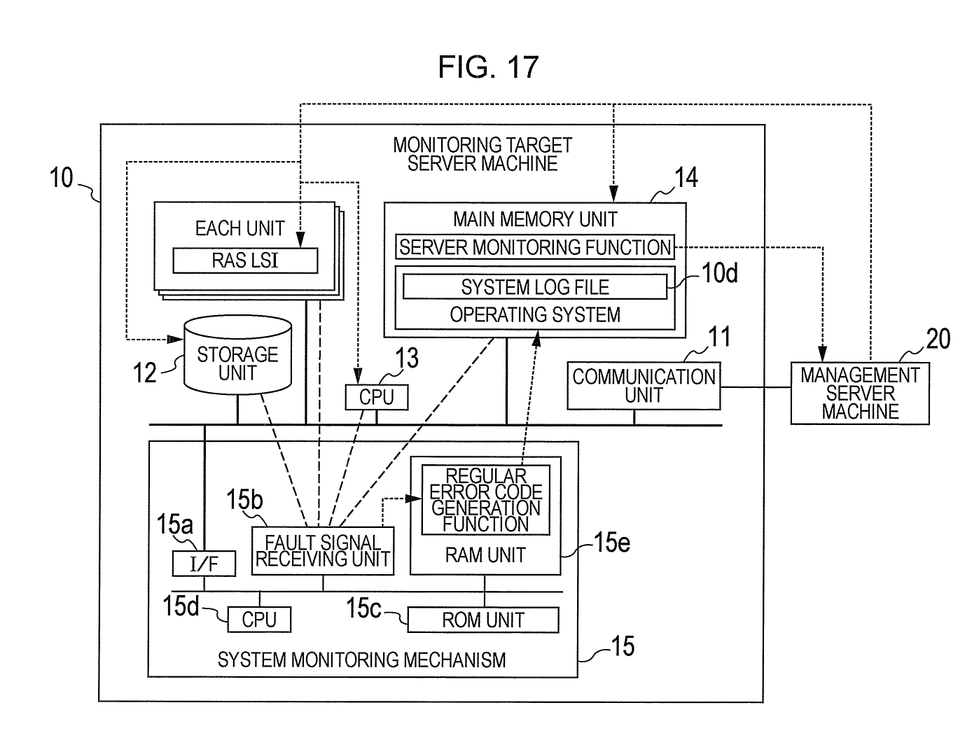

Moreover, in a second modification, for example, a main component that generates a pseudo error code may not be the periodic diagnosis module 202 in the anomaly reporting software 20b in the management server machine 20 and may be the regular error code generation program 10a in the system monitoring mechanism 15 in the monitoring target server machine 10. In the second modification, each unit such as the storage unit 12 or the CPU 13 in the monitoring target server machine 10 includes a Remote Access Service (RAS) Large Scale Integration (LSI), as illustrated in FIG. 17. The periodic diagnosis module 202 only indicates the name of the type of a pseudo fault to a RAS LSI in a unit in which the pseudo fault is caused to occur, and the RAS LSI sends a fault signal corresponding to the type of the pseudo fault, together with a signal indicating a pseudo fault, to the regular error code generation function based on the regular error code generation program 10a in the system monitoring mechanism 15. The regular error code generation function generates a pseudo error code on the basis of the fault signal and the signal indicating a pseudo fault and notifies the operating system 10c of the generated pseudo error code.

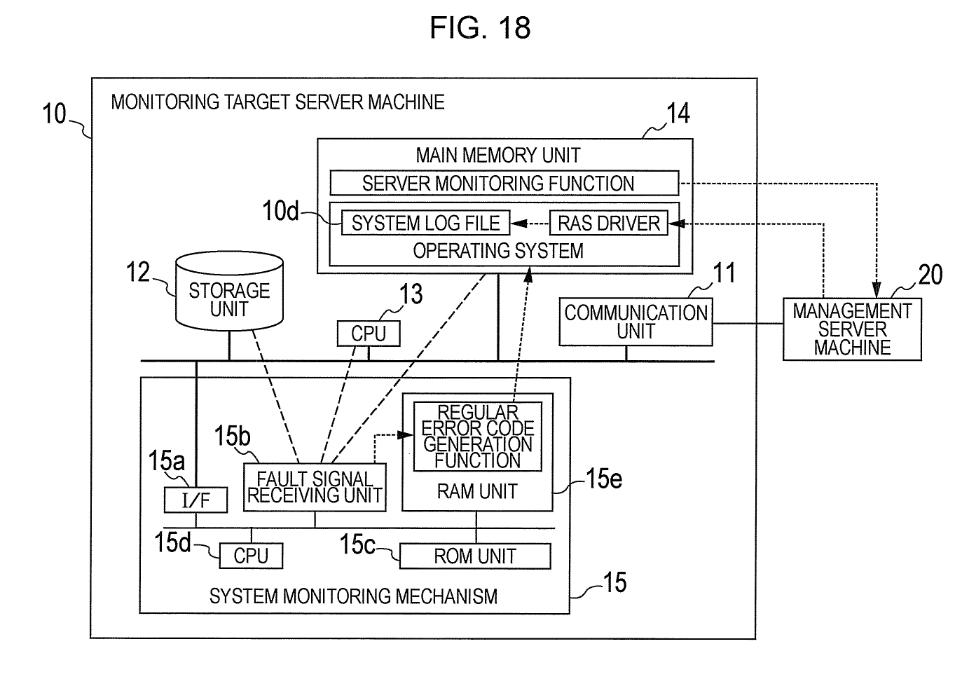

Moreover, in a third modification, for example, a main component that generates a pseudo error code may not be the periodic diagnosis module 202 in the anomaly reporting software 20b in the management server machine 20 and may be the operating system 10c of the monitoring target server machine 10. In the third modification, in the operating system 10c of the monitoring target server machine 10, a RAS driver is built in, and the type table 20d and the parts table 20e are provided, as illustrated in FIG. 18. The periodic diagnosis module 202 only indicates the part name of a unit in which a pseudo fault is caused to occur and the name of the type of the pseudo fault to the RAS driver, and the RAS driver generates a pseudo error code on the basis of the part name and the name of the type related to the pseudo fault. In this case, the RAS driver notifies the system logging function in the operating system 10c of the generated pseudo error code.

[Description about Units]

In the present embodiment and the modifications described above, any of the individual units 11 to 14 in the monitoring target server machine 10, the individual units 15a to 15e in the system monitoring mechanism 15, the individual units 21 to 25 in the management server machine 20, and the individual units 33 to 38 in the maintenance person machine 30 may include a software element and a hardware element or may include only a hardware element.

An interface program, a driver program, a table, data, and a combination of some of these elements can be exemplified as software elements. These elements may be those stored in computer-readable media described below or may be firmware that is built in storage units such as a Read Only Memory (ROM) and a Large Scale Integration (LSI) in a stationary manner.

Moreover, a Field Programmable Gate Array (FPGA), an Application Specific Integrated Circuit (ASIC), a gate array, a combination of logic gates, a signal processing circuit, an analog circuit, and another circuit can be exemplified as hardware elements. Out of these elements, logic gates may include, for example, AND, OR, NOT, NAND, NOR, flip-flop, and counter circuits. Moreover, a signal processing circuit may include circuit elements that perform addition, multiplication, division, inversion, product-sum operation, differentiation, integration, and the like of signal values. Moreover, an analog circuit may include circuit elements that perform amplification, addition, multiplication, differentiation, integration, and the like.

In this case, an element that constitutes each of the individual units 11 to 14 in the monitoring target server machine 10, the individual units 15a to 15e in the system monitoring mechanism 15, the individual units 21 to 25 in the management server machine 20, and the individual units 33 to 38 in the maintenance person machine 30 described above is not limited to the elements exemplified above and may be another element equivalent to these elements.

[Description about Software and Programs]

In the present embodiment and the modifications described above, any of the individual programs 10a and 10b, the operating system 10c, and the server monitoring software 10e in the monitoring target server machine 10, the operating system 20a, the anomaly reporting software 20b, and the individual tables 20c to 20e in the management server machine 20, the operating system 30a, the individual programs 30c and 30e, the individual tables 30b and 30d, and the mailer 30f in the maintenance person machine 30, and the aforementioned software elements may include elements such as a software component, a component based on a procedural language, an object-oriented software component, a class component, a component managed as a task, a component managed as a process, a function, an attribute, a procedure, a subroutine (a software routine), a fragment or a part of program code, a driver, firmware, microcode, code, a code segment, an extra segment, a stack segment, a program area, a data area, data, a database, a data structure, a field, a record, a table, a matrix table, an array, a variable, and a parameter.

Moreover, any of the individual programs 10a and 10b, the operating system 10c, and the server monitoring software 10e in the monitoring target server machine 10, the operating system 20a, the anomaly reporting software 20b, and the individual tables 20c to 20e in the management server machine 20, the operating system 30a, the individual programs 30c and 30e, the individual tables 30b and 30d, and the mailer 30f in the maintenance person machine 30 described above, and the aforementioned software elements may be described in the C language, C++, Java (a trademark of Sun Microsystems, Inc., USA), Visual Basic (a trademark of Microsoft Corporation, USA), Perl, Ruby, and many other programming languages.

Moreover, instructions, code, and data included in the individual programs 10a and 10b, the operating system 10c, and the server monitoring software 10e in the monitoring target server machine 10, the operating system 20a, the anomaly reporting software 20b, and the individual tables 20c to 20e in the management server machine 20, the operating system 30a, the individual programs 30c and 30e, the individual tables 30b and 30d, and the mailer 30f in the maintenance person machine 30 described above, and the aforementioned software elements may be transmitted to or loaded into a computer or a computer built in a machine or a device via a wired network card and a wired network or via a wireless card and a wireless network.

In the aforementioned transmission or loading, data signals are transferred on a wired network or a wireless network by, for example, being incorporated into carrier waves. However, data signals may be transferred in the form of what is called a baseband signal without depending on the aforementioned carrier waves. Such carrier waves are transferred in electrical, magnetic, or electromagnetic form, or in the form of light, sounds, or the like.

In this case, a wired network or a wireless network includes, for example, a telephone line, a network line, a cable (including an optical cable and a metallic cable), a radio link, a cellular phone access line, a Personal Handyphone System (PHS) network, a wireless Local Area Network (LAN), Bluetooth (a trademark of the Bluetooth Special Interest Group), in-vehicle wireless communication (including Dedicated Short Range Communication [DSRC]), and a network that includes some of them. Data signals thereon transfer information including instructions, code, and data to nodes or elements on a network.

In this case, elements that constitute the individual programs 10a and 10b, the operating system 10c, and the server monitoring software 10e in the monitoring target server machine 10, the operating system 20a, the anomaly reporting software 20b, and the individual tables 20c to 20e in the management server machine 20, the operating system 30a, the individual programs 30c and 30e, the individual tables 30b and 30d, and the mailer 30f in the maintenance person machine 30 described above, and the aforementioned software elements are not limited to those exemplified above and may be other elements equivalent to those exemplified above.

[Description about Computer-readable Media]

Some of the functions in the present embodiment and the modifications described above may be coded and stored in a storage area of a computer-readable medium. In this case, a program for implementing each of the functions can be provided to a computer or a computer built in a machine or a device via the computer-readable medium. A computer or a computer built in a machine or a device can implement the function by reading the program from the storage area of the computer-readable medium and executing the program.

In this case, a computer-readable medium is a recording medium that accumulates information such as programs and data by electrical, magnetic, optical, chemical, physical, or mechanical action and stores the information in a state in which the information can be read by a computer.

Writing data to elements on a Read Only Memory (ROM) that includes fuses can be exemplified as electrical or magnetic action. Toner development on a latent image on a paper medium can be exemplified as magnetic or physical action. Information recorded on a paper medium can be, for example, optically read. Thin film formation or projections and depressions formation on a substrate can be exemplified as optical and chemical action. Information recorded in the form of projections and depressions can be, for example, optically read. Oxidation-reduction reaction on a substrate, or oxide film formation, nitride film formation, or photoresist development on a semiconductor substrate can be exemplified as chemical action. Projections and depressions formation on an embossed card or punching a paper medium can be exemplified as physical or mechanical action.

Some computer-readable media can be mounted in computers or computers built in machines or devices so that the computer-readable media are demountable. A DVD (including a DVD-R, a DVD-RW, a DVD-ROM, and a DVD-RAM), a +R/+WR, a BD (including a BD-R, a BD-RE, and a BD-ROM), a Compact Disk (CD) (including a CD-R, a CD-RW, and a CD-ROM), a Magneto Optical (MO) disk, other optical disk media, a flexible disk (including a floppy disk [floppy is a trademark of Hitachi, Ltd.]), other magnetic disk media, a memory card (for example, CompactFlash [a trademark of SanDisk Corporation, USA], SmartMedia [a trademark of Toshiba Corporation], an SD card [a trademark of SanDisk Corporation, USA, Matsushita Electric Industrial Co., Ltd., and Toshiba Corporation], Memory Stick (a trademark of Sony Corporation), and MMC [a trademark of Siemens USA and SanDisk Corporation, USA]), a magnetic tape, other tape media, and a storage unit that includes some of them can be exemplified as demountable computer-readable media. Some storage units further include a Dynamic Random Access Memory (DRAM) or a Static Random Access Memory (SRAM).

Moreover, some computer-readable media are mounted in computers or computers built in machines or devices in a stationary manner. A hard disk, a DRAM, a SRAM, a ROM, an Electronically Erasable and Programmable Read Only Memory (EEPROM), a flash memory, and the like can be exemplified as computer-readable media of such a type.

All examples and conditional language recited herein are intended for pedagogical purposes to aid the reader in understanding the invention and the concepts contributed by the inventor to furthering the art, and are to be construed as being without limitation to such specifically recited examples and condition, nor does the organization of such examples in the specification relate to a showing of superiority and inferiority of the invention. Although the embodiment of the present inventions have been described in detail, it should be understood that the various changes, substitutions, and alternations could be made hereto without departing from the spirit and scope of the invention.

What is claimed is:

1. A system for monitoring error notification function comprising:
an information processing apparatus including:
a plurality of components for executing processes;
a first processor including error notification function for generating error information indicative of an error occurred at least one component in the information processing apparatus so as to notify the error occurred at at least one component;
a first communication unit for sending the error information; and
a management server including;
a second communication unit for receiving the error information from the information processing apparatus;
a second processor for monitoring the error notification function in the system in accordance with a process including:
instructing the information processing apparatus to generate a pseudo error command for urging the information processing apparatus to generate pseudo error information so as to check the operation of the error notification function in the system; and
wherein the second processor in the management server determines whether the error notification function in the system is operating properly or not by checking receipt of pseudo error information from the information processing apparatus.

2. A method for monitoring error notification function in an information processing apparatus, the method comprising:
executing processes in the information processing apparatus including a plurality of components;
generating error information indicative of an error occurred at least one component in the information processing apparatus so as to notify the error occurred at least one component by using a first processor in the information processing apparatus;
sending the error information by using a first communication unit in the information processing apparatus;
receiving the error information from the information processing apparatus by using a second communication unit in a management server;
instructing the information processing apparatus to generate a pseudo error command for urging the information processing apparatus to generate pseudo error information so as to check the operation of the error notification function in the system by using a second processor in the management server;
determining whether the error notification function in the system is operating properly or not by checking receipt of pseudo error information from the information processing apparatus by using the second processor in the management server.
